(19) United States
(12) Patent Application Publication
(10) Pub. No.: US 2015/0172156 A1
(43) Pub. Date: Jun. 18, 2015

(54) DETECTING END HOSTS IN A DISTRIBUTED NETWORK ENVIRONMENT

(71) Applicant: Cisco Technology, Inc., San Jose, CA (US)

(72) Inventors: Anil K. Lohiya, Cupertino, CA (US); Vipin Jain, San Jose, CA (US); Dhananjaya Rao, Milpitas, CA (US); Anand Parthasarathy, Fremont, CA (US)

(73) Assignee: CISCO TECHNOLOGY, INC., San Jose, CA (US)

(21) Appl. No.: 14/132,269

(22) Filed: Dec. 18, 2013

(51) Int. Cl. H04L 12/26; H04L 29/12

(52) U.S. Cl. CPC H04L 43/0876; H04L 61/2503; H04L 61/6068

(57) ABSTRACT

A method of one example embodiment includes receiving at a first network element a packet from a host local to the first network element destined for a remote host; determining that a subnet of the remote host is not instantiated on the first network element; originating a discovery request to discover the remote host, wherein the discovery request is originated in a Virtual Routing Forwarding instance (“VRF”) and identifies the subnet to which the remote host belongs; and broadcasting the discovery request to network elements comprising the VRF. The method may further include, upon receipt of the discovery request, determining whether the identified subnet is configured locally on the second network element and if not, dropping the discovery request; otherwise, rewriting the discovery request to include to an anycast IP address of the remote host's subnet and forwarding the rewritten request.

### TECHNICAL FIELD

This disclosure relates generally to data center networking and, more particularly, to a system, a method, and an apparatus for detecting end hosts using a node discovery protocol, such as Address Resolution Protocol (“ARP”), in a distributed network environment.

### BACKGROUND

In a typical Layer 2 (“L2”) network, a virtual Layer 3 (“L3”) interface, such as a Switched Virtual Interface (“SVI”) that may reside on routers and/or switches (“network nodes” or “nodes”) used to implement the network, is required to facilitate inter-VLAN routing. In current implementations, an SVI must be instantiated on a network node for every VLAN, or subnet, in connection with which the node is expected to perform routing tasks. In distributed network environments, an L3 boundary is brought to network devices, such as top of rack (“TOR”) or leaf nodes, attached to the hosts via SVIs. Host route distribution is used within the fabric to enable VM mobility within the fabric and encapsulation is used to avoid table capacities from being overrun on spine nodes. In order to conduct host-based L3 forwarding in a distributed network environment, the destination host must first be detected such that packets can be forwarded to the correct egress node. If the destination host of a packet has not yet been detected, the node may employ Address Resolution Protocol (“ARP”), which is a telecommunications protocol used for resolving network layer addresses into link layer addresses, to detect the destination host. In particular, the node originates an ARP request packet on the flood domain corresponding to the subnet of the destination host.

In scaled data center network environments, which may include tens of thousands of VLANs in the fabric, it is not feasible to create SVIs corresponding to all of the VLANs on all nodes of the fabric to support any-to-any inter-VLAN host communications. This poses a challenge as far as discovering the unknown destination hosts via the existing ARP mechanism if a host wants to communicate with another host in a different subnet for which an SVI has not been created locally on the node and the host is not discovered within the fabric. In such a situation, there is no way for the node to originate ARP requests for the unknown host in the bridge/flood domain without a corresponding virtual L3 interface created and assign an IP address in the unknown host's destination subnet.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of an example data communications network implemented utilizing a spine-leaf topology in accordance embodiments described herein;

FIG. 2 is a simplified block diagram of a data communications network comprising a portion of a data center configured for detecting end hosts using ARP distribution in accordance with embodiments described herein;

FIG. 3 is a flowchart illustrating an example sequence of operations for detecting a host at a leaf node using ARP distribution in accordance with embodiments described herein;

FIG. 4A is a flowchart illustrating a technique implemented by a sending leaf node configured for detecting end hosts using ARP distribution in accordance with embodiments described herein;

FIG. 4B is a flowchart illustrating a technique implemented by a receiving leaf node configured for detecting end hosts using ARP distribution in accordance with embodiments described herein; and

FIG. 5 is a simplified block diagram of a leaf node configured for detecting end hosts using ARP distribution in accordance with embodiments described herein.

### DETAILED DESCRIPTION OF EXAMPLE EMBODIMENTS

### Overview

A method is provided in one example embodiment and includes receiving at a first network element connected to a fabric network a data packet from a source host local to the first network element, in which a destination of the data packet comprises a remote host; and determining that a subnet to which the remote host belongs is not instantiated on the first network element. The method further includes originating an ARP request to discover the remote host, in which the ARP request is originated in a Virtual Routing Forwarding instance (“VRF”) and identifies the subnet to which the remote host belongs, and broadcasting the ARP request via the network fabric to all network elements comprising the VRF. The method may further include, upon receipt of the ARP request at a second network element, determining whether the subnet to which the remote host belongs, as identified in the ARP request, is configured locally on the second network element. If the identified subnet is not configured locally on the second network element, the ARP request is dropped and if the identified subnet is configured locally on the second network element, the ARP request is processed.

In certain embodiments, the processing includes rewriting a source IP address field of the ARP request to correspond to an anycast IP address of the subnet to which the remote host belongs. The method may further include forwarding the processed ARP request from the second network element to the remote host, receiving from the remote host an ARP reply in response to the ARP request, and/or propagating the ARP reply to the first network element. In some embodiments, the ARP request includes a source IP address field containing an anycast IP address of a subnet to which the local host belongs; a destination IP address field containing an IP address of the remote host; a source MAC address field containing a router MAC address of the first network element; and a destination MAC address containing a broadcast MAC address of the VRF. The first network element may be a leaf node and the fabric network comprises a plurality of interconnected spine nodes.

### EXAMPLE EMBODIMENTS

The following discussion references various embodiments. However, it should be understood that the disclosure is not limited to specifically described embodiments. Instead, any combination of the following features and elements, whether related to different embodiments or not, is contemplated to implement and practice the disclosure. Furthermore, although embodiments may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any subject matter disclosed herein and shall not be considered to be an element or limitation of the appended claims except where explicitly recited in a claim(s).

As will be appreciated, aspects of the present disclosure may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may generally be referred to herein as a “module” or “system.” Furthermore, aspects of the present disclosure may take the form of a computer program product embodied in one or more non-transitory computer readable medium(s) having computer readable program code encoded thereon.

Any combination of one or more non-transitory computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or “Flash memory”), an optical fiber, a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus or device.

Computer program code for carrying out operations for aspects of the present disclosure may be written in any combination of one or more programming languages, including an object oriented programming language such as Java™, Smalltalk™, C++ or the like and conventional procedural programming languages, such as the “C” programming language or similar programming languages.

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality and operation of possible implementations of systems, methods and computer program products according to various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in a different order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

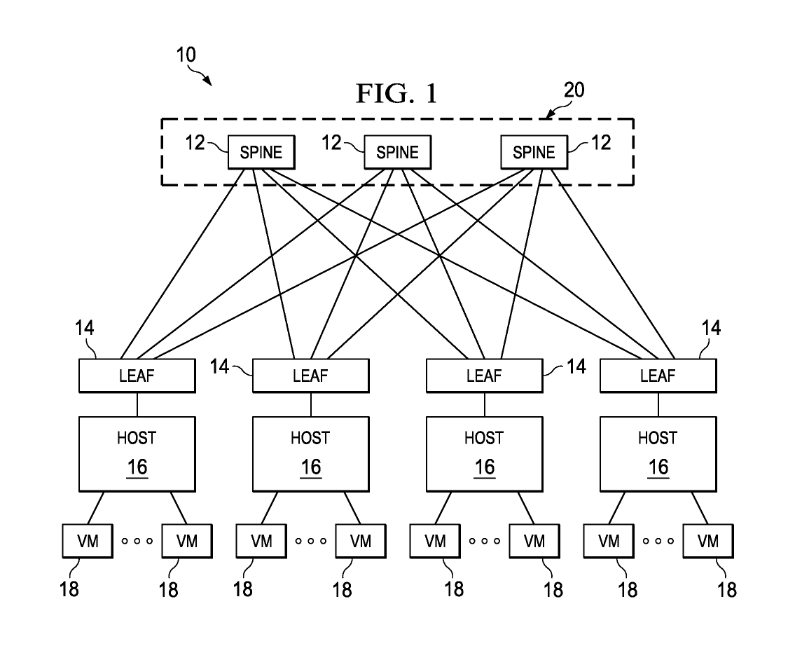

Referring initially to FIG. 1, illustrated therein is a simplified block diagram of a data communications network 10 that is implemented using a spine-leaf topology in accordance with aspects of embodiments described herein. As shown in FIG. 1, as shown in FIG. 1, the network 10 comprises a number of spine nodes 12 each of which is connected to each of a number of leaf nodes 14. One or more end hosts, or hosts, 16 may be connected to each of the leaf nodes 14. Each of the spine nodes 12 and leaf nodes 14 may be implemented using appropriate network elements comprising hardware and software, including, for example, switches, or routers, depending on the embodiment. In one embodiment, spine nodes 12 may be implemented using Nexus 7000 series switches, available from Cisco Systems, Inc. (“Cisco”), located in San Jose, Calif., and leaf nodes 14 may be implemented using Nexus 6000 series switches, also available from Cisco. In certain embodiments, hosts 16 are implemented using one or more computer devices, such as servers. Although not shown in FIG. 1, it will be recognized that each host 16 may include appropriate hardware and software elements, such as a hypervisor and a virtual switch, to support instantiation of one or more virtual machines (“VMs”), or workloads, 18. The spine nodes 12 may comprise a portion of a data center fabric 20 for implementing a Massive Scalable Data Center (“MSDC”).

As will be described in greater detail below, in one embodiment, an approach is presented for performing end host detection through ARP distribution in a distributed network environment. To this end, in data center architectures based on spine-leaf, or “fat tree” topology, such as Dynamic Fabric Automation (“DFA”), an end host may be discovered on a leaf switch to which it is directly connected through various mechanisms, such as ARP requests.

Once an end host is discovered at a leaf node, control protocols, such as Multiprotocol-Border Gateway Protocol (“MP-BGP”), may be used to distribute end host reachability information to other leaf noes so that the L2 forwarding to the end host address can be performed at the leaf nodes. A leaf node may learn the IP-MAC binding of locally-connected hosts either by intercepting ARP control packets from the hosts or by explicitly sending broadcast ARP requests in the bridge domain corresponding to the local host subnet. Currently, in order to be able to originate broadcast ARP request for the unknown host, the subnet of the unknown host must be instantiated on the leaf node. In a typical L2 network, a subnet may be assigned by creating a virtual L3 interface, such as an SVI, on the node and assigning it an IP address. This allows a node to broadcast ARP requests for the unknown host in the bridge domain corresponding to the unknown host's subnet.

In a small data center network, creating all possible SVIs on all of the network nodes may not be terribly burdensome if done on a pair of aggregation nodes, for example; however, in a typical data center implementation comprising a large number of tenants (a service provider data center, for example,) there could be tens of thousands of VLANS in the fabric. In such networks, clearly it would not be feasible to instantiate SVIs corresponding to all of the VLANs on each of the nodes in the network in order to facilitate any-to-any inter-VLAN host communication. Using the ARP mechanism as it currently exists, it is not possible for a node to discover an unknown host on a remote subnet without having an SVI for the remote subnet instantiated locally on the node. Accordingly, embodiments illustrated and described herein provide a scalable solution to this challenge, enabling use of ARP to provide a mechanism for silent hosts to speak back to the fabric thereby allowing discovery of such hosts.

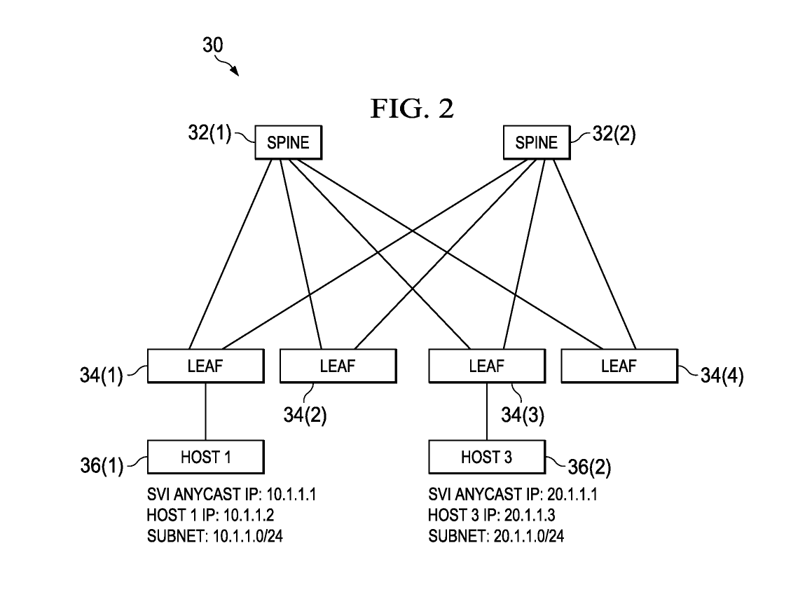

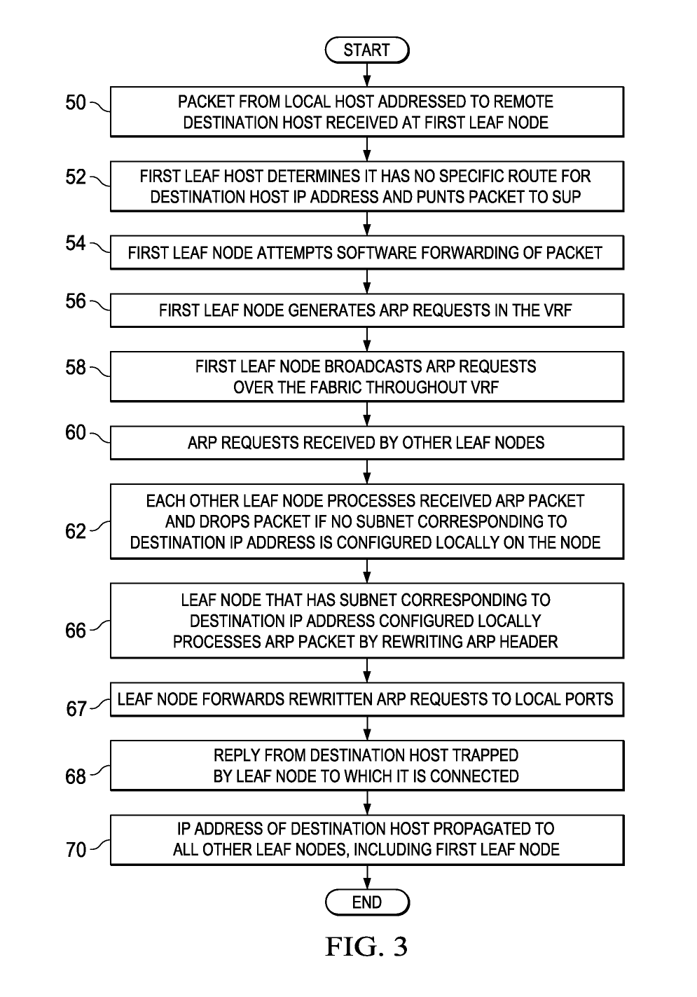

Referring now to FIG. 2, illustrated therein is a simplified block diagram of a data communications network 30 comprising a portion of a data center configured for detecting end hosts using ARP distribution in accordance with embodiments described herein. Similar to the network 10, the network 30 comprises multiple spine nodes 32(1) and 32(2) each connected to each of several leaf nodes 34(1)-34(4). For purposes of illustration, only two end hosts are shown. The first end host 36(1) is connected to leaf node 34(1). The second end host 36(2) is connected to leaf node 34(3). It will now be assumed for the sake of example that leaf node 34(1) has subnet 10.1.1.0/24 instantiated thereon with an anycast gateway address on the corresponding SVI interface designated as 10.1.1.1. It will be similarly assumed for the sake of example that leaf node 34(3) has a subnet 20.1.1.0/24 instantiated thereon with an anycast IP address on the corresponding SVI designed as 20.1.1.1. Leaf node 34(4) is assumed to be another leaf node and therefore does not require any subnet to be instantiated thereon unless it is acting as a leaf switch for local hosts as well (which in the currently illustrated configuration, it is not). Further, it will be assumed that the SVI interfaces on leaf nodes 34(1) and 34(3) are configured in an anycast-gateway mode. It will be further assumed that leaf node 34(1) does not have subnet 20.1.1.0/24 instantiated on it. Host 36(1), which has an IP address of 10.1.1.2 has already been detected by leaf node 34(1); similarly, host 36(2), which has an IP address of 20.1.1.3, has not only already been detected by leaf node 34(3). Host 36(2) has not yet been detected by leaf node 34(1). Now, assuming that host 36(1) wants to communicate with (send a packet to) host 36(2), which as previously mentioned has not yet been detected by leaf node 36(1), the sequence of operations to detect host 36(2) at leaf node 34(1) may be described as follows with reference to FIG. 3.

Referring to FIG. 3, in step 50, a packet from host 36(1) addressed to host 36(2) is received on leaf node 34(1). In step 52, leaf node 34(1) references its Forwarding Information Base (“FIB”) table and punts the packet to the node's supervisor engine (“SUP”), since there is no specific route in the FIB for IP address 20.1.1.3. Note that in order for the FIB to punt the packet up to the SUP, there must be some punt route installed in the FIB. This could be based either on a static Command Line Interface (“CLI”) configuration or through BGP distribution of prefix routes. In step 54, after the packet has been punted up to the SUP on leaf node 34(1), software forwarding of the packet is attempted. If a route to the destination does not exist, but the destination subnet is instantiated on the leaf node 34(1), an ARP request will be originated to detect the host 36(2). However, in accordance with features of embodiments described herein, to support prefix-based forwarding without instantiating the subnet 20.1.1.0/24, an exception is performed in the software so that the ARP request packet is originated in the entire Virtual Routing Forwarding instance (“VRF”). In step 56, ARP requests are generated in the VRF on the leaf 34(1). The ARP requests are generated with the source IP corresponding to the anycast IP address of the SVI in which the packet was received (in this case, 10.1.1.1) and the destination IP address of the host 36(2) (20.1.1.3). The source MAC address may be set to the MAC address of leaf node 34(1) and the destination MAC address will be set to the broadcast MAC address.

In step 58, the ARP requests are then broadcast over the fabric to all of the other nodes that have instantiated the VRF. The fabric transport can be an L2 tunneling technology, such as Cisco FabricPath or IP-based Virtual eXtensible Local Area Network (“VXLAN”). Each ARP request is sent with a Virtual Network Identifier (“VNI”) corresponding to the VRF in which the ARP request is being sent. In step 60, ARP requests are received over the fabric interface on all of the nodes of the network 30 belonging to the corresponding VRF. It will be assumed that the subnet 20.1.1.0/24 is instantiated on leaf node 34(3) only. In step 62, at each leaf node 34(2)-34(4), when the ARP request packet is received over the fabric interface comprising spine nodes 32(1)-32(2), the ARP packet is looked up further to check on the destination IP address. If the subnet corresponding to the destination IP address in the ARP packet is configured locally on the switch, the received packet is processed; otherwise, it is dropped.

More particularly, based on the look up performed in step 60, in step 62, the ARP packets received at leaf nodes 34(2)-34(4), respectively, are dropped at leaf nodes 34(2) and 34(4), and further processed at leaf node 34(3). In step 66, leaf node 32(3) processes the received ARP packet by rewriting the ARP header of the received packet. In particular, the original ARP packet received over the fabric had the source IP address field set to the anycast IP address corresponding to the source subnet (10.1.1.1). When leaf node 32(3) regenerates the ARP request packet, the source IP address field in the packet must correspond to the anycast IP address of the destination subnet. Accordingly, the source IP address field in the ARP request packet sent toward the local ports of leaf node 34(3) must be set to 20.1.1.1. In step 67, when leaf node 34(3) broadcasts the ARP requests toward local (non-fabric) ports, the ARP reply from host 36(3) is trapped by leaf node 34(3) in step 68. In step 70, the IP address of host 36(3) (20.1.1.3) is propagated (e.g., through BGP or other appropriate means) to all of the other leaf nodes 34(1), 34(2), and 34(4).

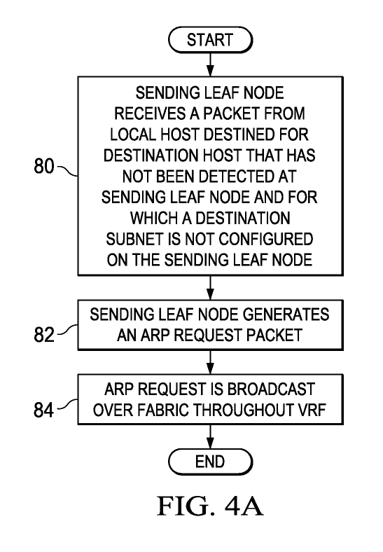

FIG. 4A is a flowchart illustrating a technique implemented by a sending leaf node configured for detecting end hosts using ARP distribution in accordance with embodiments described herein. As shown in FIG. 4A, in step 80, the sending leaf node receives a packet from a local end host destined for a destination host that has not yet been detected at the sending leaf node and for which a destination subnet is not configured on the sending leaf node. In step 82, the sending leaf node generates an ARP request packet with the source IP address field set to the anycast IP address of the SVI in which the packet was received, the destination IP address field set to the IP address of the destination host, the source MAC address field set to the router MAC address of the sending leaf node, and the destination MAC address field set to the broadcast MAC address for the VRF. In step 84, the ARP request is broadcast over the fabric to all other nodes in the network for a corresponding VRF.

FIG. 4B is a flowchart illustrating a technique implemented by a receiving leaf node configured for detecting end hosts using ARP distribution in accordance with embodiments described herein. As shown in FIG. 4B, in step 90, the receiving leaf node receives an ARP request and determines whether the destination IP address indicated therein corresponds to the subnet configured locally on the receiving leaf node. If not, in step 92, the packet is dropped; otherwise, in step 94, the packet is processed. In particular, the processing includes rewriting the ARP header such that the source IP address field is rewritten to comprise the anycast IP address of the destination subnet. In step 96, the processed ARP request is sent toward the local ports of the receiving leaf node. In step 98, the destination end host responds to the ARP request and the ARP reply is trapped by the sending leaf node. In step 100, the IP address of the destination end host is propagated (e.g., using BGP) to all of the other leaf nodes in the VRF.

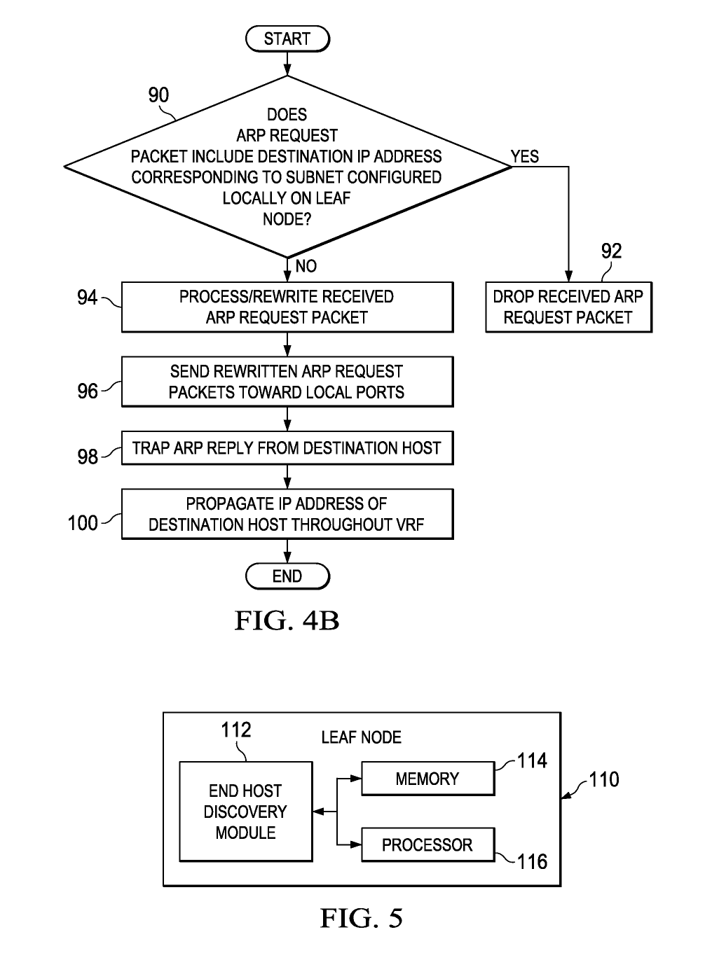

In one example implementation, various nodes involved in implementing the embodiments described herein can include software for achieving the described functions. For example, referring to FIG. 5, each of the leaf nodes of the embodiments described herein, represented in FIG. 5 by a leaf node 110, may include an end host discovery module 112 comprising software embodied in one or more tangible media for facilitating the activities described herein for detecting a host at a leaf node using ARP distribution in accordance with embodiments described herein and particularly as illustrated in FIGS. 3, 4A, and 4B. The node 110 may also include a memory device 114 for storing information to be used in achieving the functions as outlined herein. Additionally, the node 110 may include a processor 116 that is capable of executing software or an algorithm (such as embodied in module 112) to perform the functions as discussed in this Specification.

As a result of the embodiments illustrated and described herein, not all of the virtual L2 interfaces corresponding to each subnet in the network need to be instantiated on all of the nodes in the network to which they are non-local (meaning that there are no local hosts in those subnets connected to a node). Additionally, it is not necessary for all of the nodes to know or instantiate any hardware resource for the target subnet segment (that represent a target segment or VNI). This makes the embodiments highly scalable, as they avoid allocation of unnecessary resources (namely, SVI interfaces) corresponding to non-local subnets on a node. Additionally, embodiments shown and described herein render it possible to detect and communicate with silent hosts in a scaled environment, as the creation of SVIs for hosts not local to a node is not necessary. Finally, if the instantiation of SVIs is driven through a central point of management, such as described and shown herein, the central point of management doesn't need to know what VMs can be provisioned on which of the available leaf nodes depending on what remote hosts the local VM might communicate with. Absent the techniques depicted and shown herein, instantiation of a VM may bring in additional burdens of instantiating SVIs for the remote host subnets with which a VM communicates.

It should be noted that much of the infrastructure discussed herein can be provisioned as part of any type of network device. As used herein, the term “network element” can encompass computers, servers, nodes, network appliances, hosts, routers, switches, gateways, bridges, virtual equipment, load-balancers, firewalls, processors, modules, or any other suitable component, element, endpoints, user equipments, handheld devices, or object operable to exchange information in a communications environment. Moreover, the network devices may include any suitable hardware, software, components, modules, interfaces, or objects that facilitate the operations thereof. This may be inclusive of appropriate algorithms and communication protocols that allow for the effective exchange of data or information.

In one implementation, these devices can include software to achieve (or to foster) the activities discussed herein. This could include the implementation of instances of any of the components, engines, logic, modules, etc., shown in the FIGURES. Additionally, each of these devices can have an internal structure (e.g., a processor, a memory element, etc.) to facilitate some of the operations described herein. In other embodiments, the activities may be executed externally to these devices, or included in some other device to achieve the intended functionality. Alternatively, these devices may include software (or reciprocating software) that can coordinate with other elements in order to perform the activities described herein. In still other embodiments, one or several devices may include any suitable algorithms, hardware, software, components, modules, interfaces, or objects that facilitate the operations thereof.

Note that in certain example implementations, functions outlined herein may be implemented by logic encoded in one or more non-transitory, tangible media (e.g., embedded logic provided in an application specific integrated circuit (“ASIC”), digital signal processor (“DSP”) instructions, software (potentially inclusive of object code and source code) to be executed by a processor, or other similar machine, etc.). In some of these instances, a memory element, as may be inherent in several devices illustrated in the FIGURES, can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, the processor, as may be inherent in several devices illustrated in FIGS. 1-4, including, for example, servers, fabric interconnects, and virtualized adapters, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable ROM (“EEPROM”)) or an ASIC that includes digital logic, software, code, electronic instructions, or any suitable combination thereof.

The devices illustrated herein may maintain information in any suitable memory element (random access memory (“RAM”), ROM, EPROM, EEPROM, ASIC, etc.), software, hardware, or in any other suitable component, device, element, or object where appropriate and based on particular needs. Any of the memory items discussed herein should be construed as being encompassed within the broad term “memory element.” Similarly, any of the potential processing elements, modules, and machines described in this Specification should be construed as being encompassed within the broad term “processor.” Each of the computer elements can also include suitable interfaces for receiving, transmitting, and/or otherwise communicating data or information in a communications environment.

Note that with the example provided above, as well as numerous other examples provided herein, interaction may be described in terms of two, three, or four computer elements. However, this has been done for purposes of clarity and example only. In certain cases, it may be easier to describe one or more of the functionalities of a given set of flows by only referencing a limited number of system elements. It should be appreciated that systems illustrated in the FIGURES (and their teachings) are readily scalable and can accommodate a large number of components, as well as more complicated/sophisticated arrangements and configurations. Accordingly, the examples provided should not limit the scope or inhibit the broad teachings of illustrated systems as potentially applied to a myriad of other architectures.

It is also important to note that the steps in the preceding flow diagrams illustrate only some of the possible signaling scenarios and patterns that may be executed by, or within, the illustrated systems. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the illustrated systems in that any suitable arrangements, chronologies, configurations, and timing mechanisms may be provided without departing from the teachings of the present disclosure. Although the present disclosure has been described in detail with reference to particular arrangements and configurations, these example configurations and arrangements may be changed significantly without departing from the scope of the present disclosure. In particular, it will be recognized that other protocols for performing discovery of nodes in a network environment, such as Neighbor Discovery Protocol (“NDP”) applicable to Internet Protocol Version 6 (“IPv6”) networks, may be advantageously implemented using the above-described techniques without departing from the spirit of the embodiments described herein.

Numerous other changes, substitutions, variations, alterations, and modifications may be ascertained to one skilled in the art and it is intended that the present disclosure encompass such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving at a first network element connected to a fabric network a data packet from a source host local to the first network element, wherein a destination of the data packet comprises a remote host;
determining that a subnet to which the remote host belongs is not instantiated on the first network element;
originating a discovery request to discover the remote host, wherein the discovery request is originated in a Virtual Routing Forwarding instance (“VRF”) and identifies the subnet to which the remote host belongs; and
broadcasting the discovery request via the network fabric to all network elements comprising the VRF.

2. The method of claim 1, further comprising;
upon receipt of the discovery request at a second network element, determining whether the subnet to which the remote host belongs, as identified in the discovery request, is configured locally on the second network element;
if the identified subnet is not configured locally on the second network element, dropping the discovery request;
if the identified subnet is configured locally on the second network element, processing the discovery request.

3. The method of claim 2, wherein the processing comprises rewriting a source IP address field of the discovery request to correspond to an anycast IP address of the subnet to which the remote host belongs.

4. The method of claim 2 further comprising forwarding the processed discovery request from the second network element to the remote host.

5. The method of claim 4, further comprising receiving from the remote host a discovery reply in response to the discovery request.

6. The method of claim 5, further comprising propagating the discovery reply to the first network element.

7. The method of claim 1, wherein the discovery request comprises:
a source IP address field containing an anycast IP address of a subnet to which the local host belongs;
a destination IP address field containing an IP address of the remote host;
a source MAC address field containing a router MAC address of the first network element; and
a destination MAC address containing a broadcast MAC address of the VRF.

8. The method of claim 1, wherein the first network element comprises a leaf node.

9. The method of claim 1, wherein the fabric network comprises a plurality of interconnected spine nodes.

10. One or more non-transitory tangible media that includes code for execution and when executed by a processor is operable to perform operations, comprising:
receiving at a first network element connected to a fabric network a data packet from a source host local to the first network element, wherein a destination of the data packet comprises a remote host;
determining that a subnet to which the remote host belongs is not instantiated on the first network element;
originating a discovery request to discover the remote host, wherein the discovery request is originated in a Virtual Routing Forwarding instance (“VRF”) and identifies the subnet to which the remote host belongs; and
broadcasting the discovery request via the network fabric to all network elements comprising the VRF.

11. The media of claim 10, further including code for execution and when executed by a processor is operable to perform operations comprising:
upon receipt of the discovery request at a second network element, determining whether the subnet to which the remote host belongs, as identified in the discovery request, is configured locally on the second network element;
if the identified subnet is not configured locally on the second network element, dropping the discovery request;
if the identified subnet is configured locally on the second network element, processing the discovery request.

12. The media of claim 11, wherein the processing comprises rewriting a source IP address field of the discovery request to correspond to an anycast IP address of the subnet to which the remote host belongs.

13. The media of claim 11, further including code for execution and when executed by a processor is operable to perform operations comprising:
forwarding the processed discovery request from the second network element to the remote host;
receiving from the remote host an discovery reply in response to the discovery request; and
propagating the discovery reply to the first network element.

14. The media of claim 10, wherein the discovery request comprises:
a source IP address field containing an anycast IP address of a subnet to which the local host belongs;
a destination IP address field containing an IP address of the remote host;
a source MAC address field containing a router MAC address of the first network element; and
a destination MAC address containing a broadcast MAC address of the VRF.

15. The media of claim 10, wherein the first network element comprises a leaf node and the fabric network comprises a plurality of interconnected spine nodes.

16. An apparatus, comprising:
a memory element configured to store data;
a processor operable to execute instructions associated with the data; and
an end host discovery module configured to:
receive at a first network element connected to a fabric network a data packet from a source host local to the first network element, wherein a destination of the data packet comprises a remote host;
determine that a subnet to which the remote host belongs is not instantiated on the first network element;
originate a discovery request to discover the remote host, wherein the discovery request is originated in a Virtual Routing Forwarding instance (“VRF”) and identifies the subnet to which the remote host belongs; and
broadcast the discovery request via the network fabric to all network elements comprising the VRF.

17. The apparatus of claim 16, wherein the end host discovery module is further configured to:
upon receipt of the discovery request at a second network element, determine whether the subnet to which the remote host belongs, as identified in the discovery request, is configured locally on the second network element;
if the identified subnet is not configured locally on the second network element, drop the discovery request;
if the identified subnet is configured locally on the second network element, process the discovery request.

18. The apparatus of claim 17, wherein the processing comprises rewriting a source IP address field of the discovery request to correspond to an anycast IP address of the subnet to which the remote host belongs.

19. The apparatus of claim 16, further including code for execution and when executed by a processor is operable to perform operations comprising:
forwarding the processed discovery request from the second network element to the remote host;
receiving from the remote host an discovery reply in response to the discovery request; and
propagating the discovery reply to the first network element.

20. The apparatus of claim 16, wherein the discovery request comprises:
a source IP address field containing an anycast IP address of a subnet to which the local host belongs;
a destination IP address field containing an IP address of the remote host;
a source MAC address field containing a router MAC address of the first network element; and
a destination MAC address containing a broadcast MAC address of the VRF.
